(19) United States
(12) Patent Application Publication
(10) Pub. No.: US 2003/0217473 A1
(43) Pub. Date: Nov. 27, 2003

(54) B-Dangler

(76) Inventor: Ronald Lee Pampel, Tampa, FL (US)

Correspondence Address: Ronald L. Pampel, 6305 Lansdale Cr., Tampa, FL, 33616, US

(21) Appl. No.: 10/151,548

(22) Filed: May 21, 2002

(51) Int. Cl. B43L 7/10

(52) U.S. Cl. 33/471

(57) ABSTRACT

Opening and closing the tool causes (I) the double headed pointer to slide back and forth along (a1) the slot in (A) the Lower Faceplate. Along both of the sides of (a1) the slot are marked with increments of pre-calibrated measurement. Each side may hold a different type of measurement. Example; Degrees, Inches, or Millimeters.

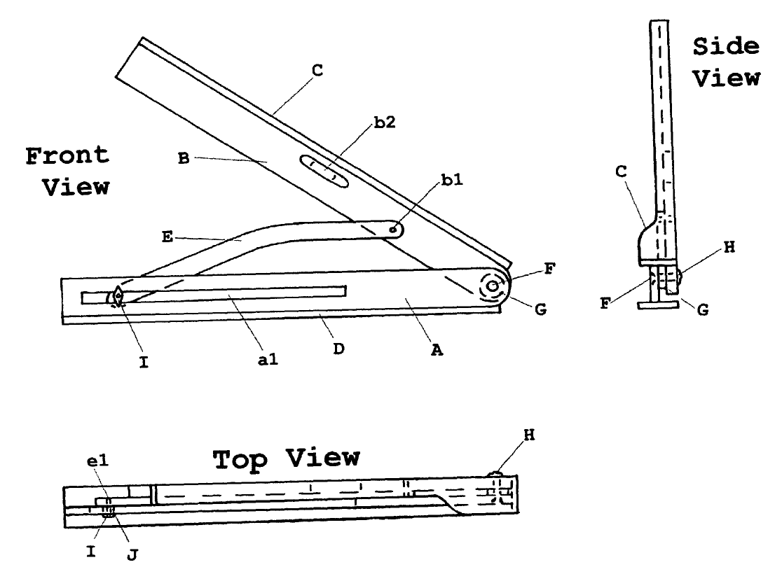

(b2) the bubble level helps to make certain that at least part of the tool can be held level, depending on the type of measurement made.

The tool can be fully opened causing (D) the Lower Base Plate to butt up with (C) the Upper Base Plate to make a long straight edge, and coinciding measurement.

Using (G) the nylon nut together with (F) the hinge bolt and (H) the lock nut as the tension point helps to prevent measurement slippage without any further physical action. Reusable with each tightening.

With pre-calibrated increments of measurement marked, some measurements may be made beyond the compact size of the tool.

This tool I call the B-Dangler. It is designed as a two faced unit, each with coinciding bases. The faces being joined at one end and facing the same direction are allowed to pivot, which activates a swing arm between them. The swing arm at one end, is attached to one face unit at a single point causing a second pivot action. The other end of the swing arm has a pointer attached to it, which runs through and slides, along a slot cut in the other face. Measurements are marked along this slot. The base plates on each perspective faceplate are placed in such a manner to cause them to butt together upon opening the tool to its full extent of the pivot, giving a long straight edge. Measurements too, are marked along this straight edge. A bubble level allows for the upper faceplate to be held level while the lower faceplate dangles downward along a measurable slope.

### BACKGROUND

Cutting material accurately to fit flush into an inner angled boundary can end in consuming large amounts of wasted time and supplies, unless using an accurate way to convert measurements to a jig. Circumference can also be figured by simply making accurate measurements of angles or slope.

### DRAWING

The drawing depicts this tool as whole and appropriately connected together. Each separate part, whether working or connecting, is marked in letters which are referred to in ( ) in the description below.

No other key is needed.

### DRAWING DESCRIPTION

(A)- Lower Faceplate; 12″L×1″H×⅛″ D with a ½″ radius cut off the hinge end using the hinge bolthole for the center point.

(a1)- slot cut beginning at 4⅛″ from bolthole center point, to the length of 7″ at a ¼″ wide.

(B)- Upper Faceplate; 12″L×1″H×⅛″D with a ½″ radius cut off the hinge end using the hinge bolthole for the center point.

(b1)- ⅛″ rivet, ¼″ long, pivot mounts (E) Guide Bar to (B) Upper Faceplate.

(b2)- ½″ bubble level flush mounted to (B) the Upper Faceplate, at the center of the length and above center of the height.

(C)- Upper Base Plate; 11½″L×⅛″H. The Depth is cut to 1″ for the first 1½″ beginning in line with and above the center of the bolthole of (B) the Upper Faceplate and mounted with both straight back sides running perpendicular. The remaining 10″ is cut to ½″ measuring from the straight backside.

(D)- Lower Base Plate; 11½″L×1″H×1″D mounted beginning inline with and below the bolthole of (A) the Lower Faceplate and positioned in such a way as ¼″ of Base Plate is exposed from the backside of the Lower Faceplate.

(E)- Guide Bar; ⅜″H×⅛″D and an over all length 8″. With a13 degree angle measuring at 3½″ to center from the (b1) end and angles down the remaining 4½″ to the (el) end.

(e1)- ⅛″ rivet, 5/16″ long, pivot mounting (I & J) the pointer and pointer base to (E) the Guide Bar, through (a1) the slot cut in (A) the Lower Faceplate.

(F)- Tapered head hinge bolt, ⅜″ fine thread, ½″ long.

(G)- Nylon spacer, ½″ dia. ⅛″ thick.

(H)- Lock nut, for (F) hinge bolt.

(I)- Double headed pointer, ½″ from point to point. 1/16″ thick.

(J)- Oval base attached to or part of the pointer, 3/16″×¼″.

1)- As (A) the Lower Faceplate and (B) the Upper Faceplate are swung apart, (E) the Guide Bar slides along the length of (a1) the slot in (A) the Lower Faceplate, with (1) the double headed pointer, pointing towards each side. Pre-calibrated and numerical lines of measurement mark each side, along the length of (a1) the slot.

2)- Some pre-calibrated measurements may come from beyond the length of its own compact size.

3)- The top side of (D) the Lower Base Plate in front of (A) the Lower Faceplate, is marked with exact measurement. Along a straight edge example, 0-11½″ or 0-290 mm.

4)- The bottom side of (D) the Lower Base Plate is marked in unison with the bottom, straight edge side of (C) the Upper Base Plate to double the size of straight edge as they butt together with tool fully opened. Along a straight edge example, 0-23″ or 0-580 mm.

5)- (G) The nylon spacer allows (F) the hinge bolt to be tightened enough to use as the tension point which keeps measurements from slipping before being read. (H) The lock nut helps to hold the tension, while allowing for adjustment.

6)- (b2) The bubble level set in (B) the Upper Faceplate makes it possible to measure downward angles. (A) The Lower faceplate swings down while (B) the Upper Faceplate is held level.

7)- Measurements given to build this tool are taken directly from its prototype and is found to be appropriate for many functions while keeping a compact size. Any slight variation will not change the sum of the design.
